(19) United States
(12) Patent Application Publication
(10) Pub. No.: US 2006/0051982 A1
(43) Pub. Date: Mar. 9, 2006

(54) Combinational AV socket

(76) Inventor: Huang Chou Huang, Taipei (TW)

Correspondence Address: PRO-TECHTOR INTERNATIONAL SERVICES, 20775 Norada Court, Saratoga, CA, 95070-3018, US

(21) Appl. No.: 10/937,229

(22) Filed: Sep. 8, 2004

(51) Int. Cl. H01R 12/00

(52) U.S. Cl. 439/63

(57) ABSTRACT

A combinational AV socket comprises a male pedestal and a female base; the cross section of the male pedestal is in “I” shape, a pair of dovetail shape protruding clip ribs are on both center sides of the male pedestal, a pair of dovetail shape clip hooks with proper elasticity are on top and down of the protruding clip rib; a round hollow plug with elastic slice is on the front of the female base, a pair of dovetail shape concave slots corresponding to the protruding clip ribs of the male pedestal are on both center side of the female base, a pair of clip slots corresponding to the clip hooks are on top and down of the concave slot, the front of the clip slot has deeper depth than the rear to form a proper oblique slope; the female bases with different colors are combined with the male pedestal with the protruding clip ribs, the clip hooks on top and down of the protruding clip ribs move along the clip slots, the oblique slope and across the wall of the clip slot to hook on the front of the wall, the AV sockets are in parallel with different colors for signal lines with different colors to

[symbol]

### BACKGROUND OF THE INVENTION

I. Field of the Invention

This invention relates generally to an AV socket and, more specifically, to a combinational AV socket that can be manufactured and sold alone, no need to have color rings to differentiate, and very easy to assemble.

II. Description of the Prior Art

Heretofore, it is known that those AV sockets applied in stereo systems and TV's need different colors to correspond to signal lines with the same color to differentiate video, audio and signals, the color marks of the known sockets is done by stuffing color rings on the front of the finished sockets, this method increase manufacturing process; the socket type is fixed can not be sold, manufactured separately.

### SUMMARY OF THE INVENTION

It is therefore a primary object of the invention to provide a combinational AV socket that has sockets with different colors to be manufactured and sold separately, multiple sockets can be installed in line for different application, the sockets with different colors can alter position as desire.

In order to achieve the objective set forth, a combinational AV socket in accordance with the present invention comprises a male pedestal and a female base; the cross section of the male pedestal is in “I” shape, a pair of dovetail shape protruding clip ribs are on both center sides of the male pedestal, a pair of dovetail shape clip hooks with proper elasticity are on top and down of the protruding clip rib. A round hollow plug is on the front of the female base, a pair of dovetail shape concave slots corresponding to the protruding clip ribs of the male pedestal are on both center side of the female base, a pair of clip slots corresponding to the clip hooks are on top and down of the concave slot, the front of the clip slot has deeper depth than the rear to form a proper oblique slope, the female bases with different colors are combined with the male pedestal with the protruding clip ribs, the clip hooks on top and down of the protruding clip ribs move along the clip slots, the oblique slope and across the wall of the clip slot to hook on the front of the wall, the male pedestals and the female bases are combined firmly together, the AV sockets are in parallel with different colors for signal lines with different colors to plug in.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1, FIG. 2 are the perspective views of a further embodiment the present invention;

FIG. 3, FIG. 4 are the perspective view of another further embodiment the present invention;

FIG. 5, FIG. 6 are the assembly view of the present invention;

FIG. 7 is an application view of the present invention;

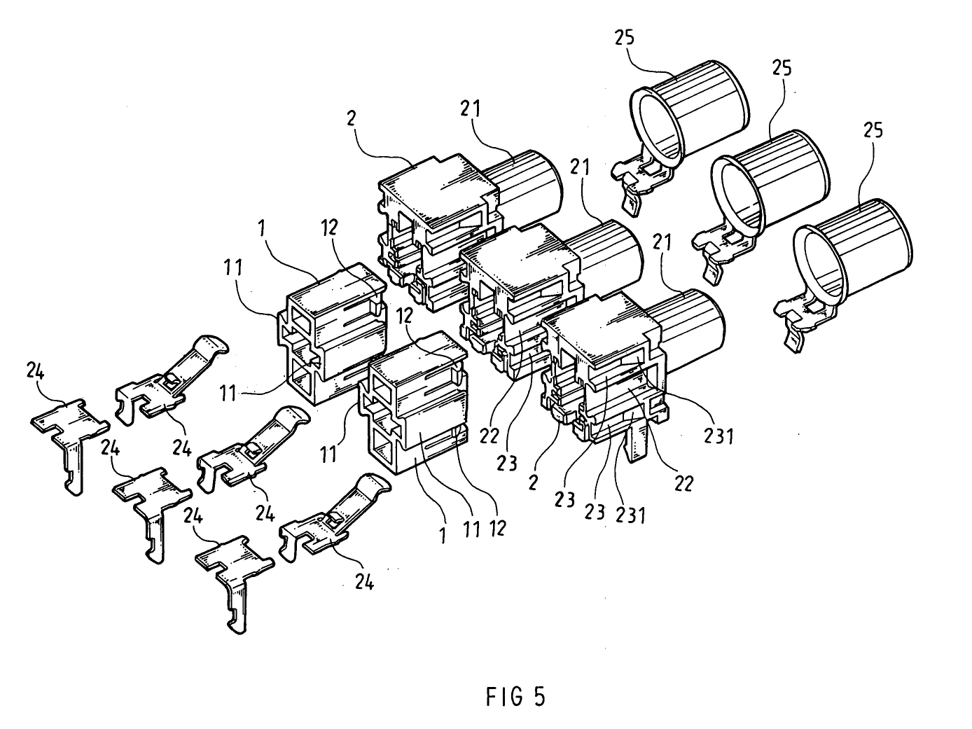

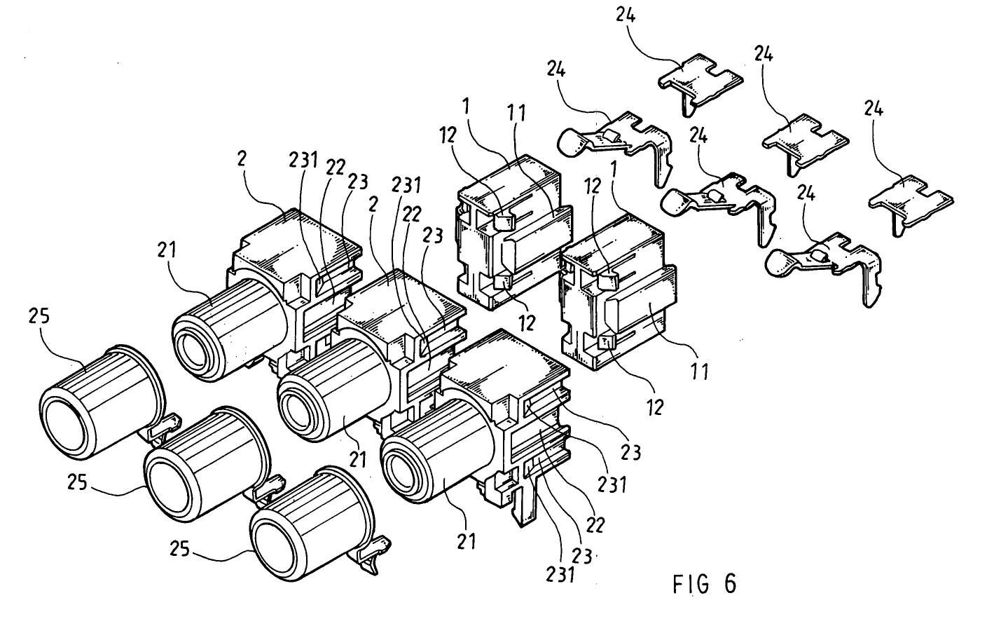

FIG. 5 is a cross-sectional view of the present invention.

### DESCRIPTION OF THE PREFERRED EMBODIMENT

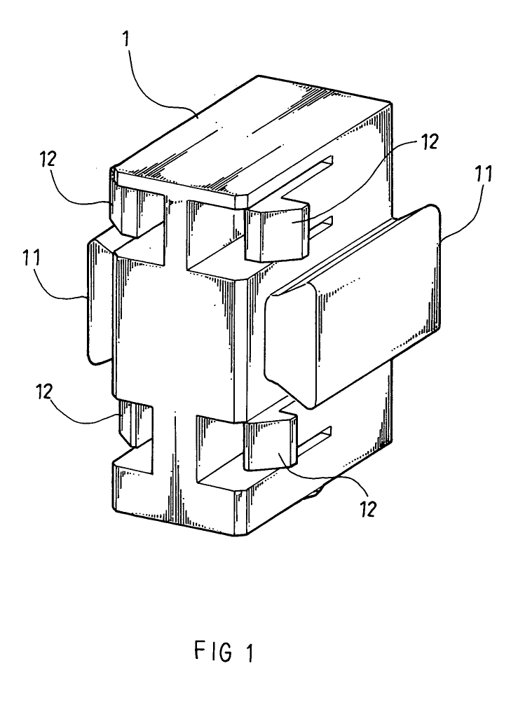

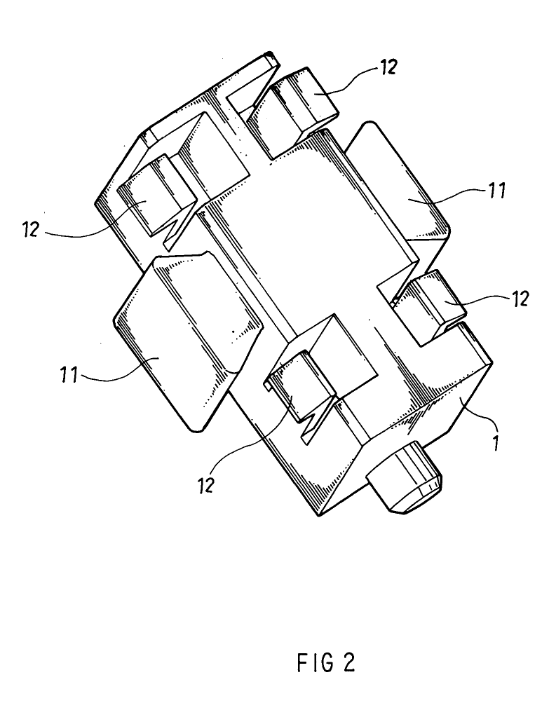

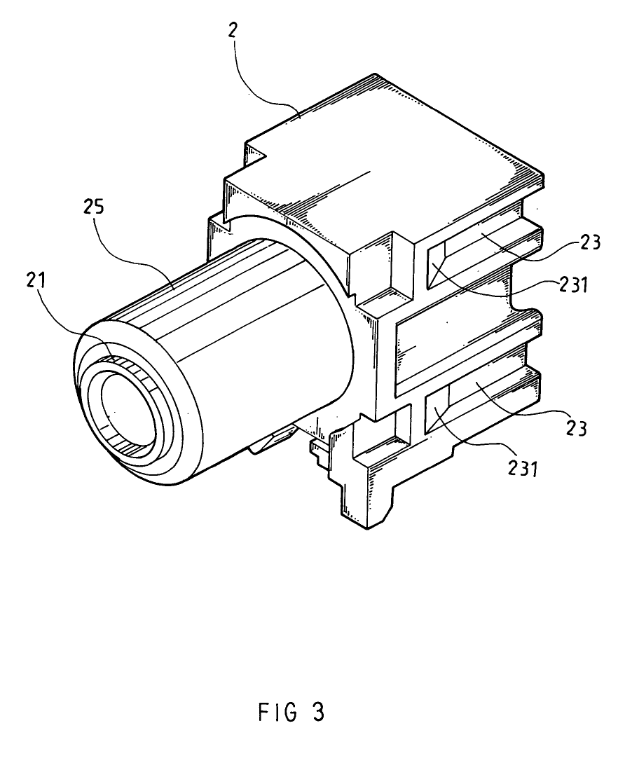

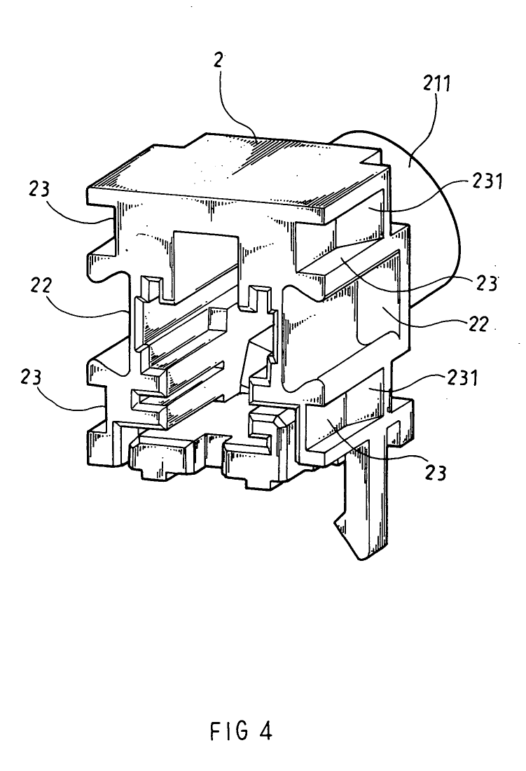

Referring to FIG. 1 to FIG. 4, the present invention comprises a male pedestal 1 and a female base 2; the cross section of the male pedestal 1 is in “I” shape, a pair of dovetail shape protruding clip ribs 11 are on both center sides of the male pedestal 1, a pair of clip hooks 12 with proper elasticity are on top and down of the protruding clip rib 11.

A round hollow plug 21 is on the front of the female base 2, a pair of dovetail shape concave slots 22 corresponding to the protruding clip ribs 11 of the male pedestal 1 are on both center side of the female base 2, a pair of clip slots 23 corresponding to the clip hooks 12 are on top and down of the concave slot 22, the front of the clip slot 23 has deeper depth than the rear to form a proper oblique slope 231.

Based on the structure described above, the female bases 2 are made with different colors; while assembly, an elastic slice 24 is installed inside, a metal sleeve 25 is placed onto the plug 21 to form a socket with definite color, such mechanism can be sold separately or combine dynamically with other AV sockets in parallel.

Referring to FIG. 5 and FIG. 6, while assembly, different female bases 2 with different colors are aligned in line, the protruding clip ribs 11 of the male pedestal 1 wedge into the concave slots 22 of the female base 2 and link multiple female bases 2, when the protruding clip ribs 11 slide into the concave slots 22, the clip hooks 12 on top and down of the protruding clip ribs 11 move along the clip slots 23, the oblique slope 231 and across the wall of the clip slot 23 to hook on the front of the wall, the male pedestals 1 and the female bases 2 are combined firmly together, the AV sockets are in parallel with different colors for signal lines with different colors to plug in.

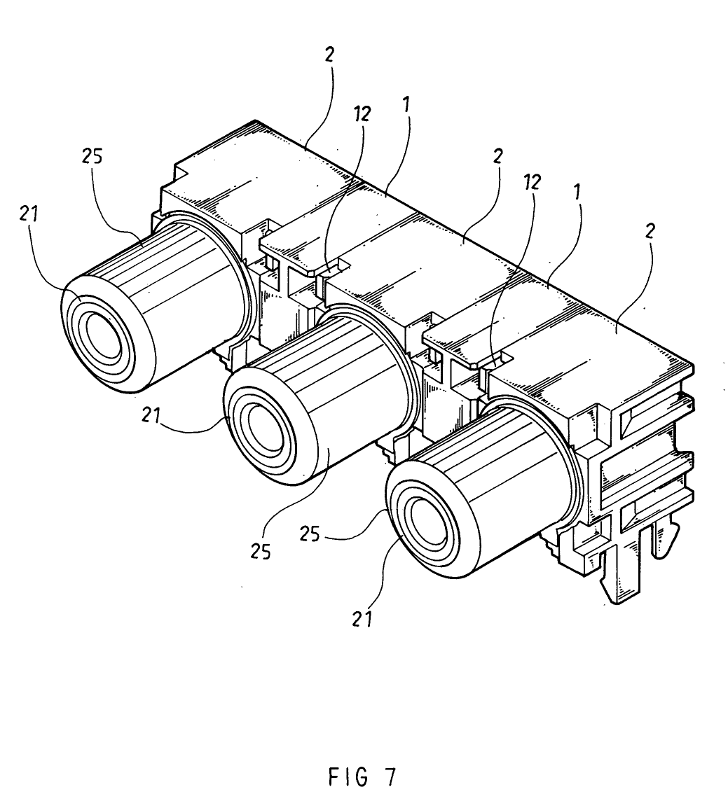

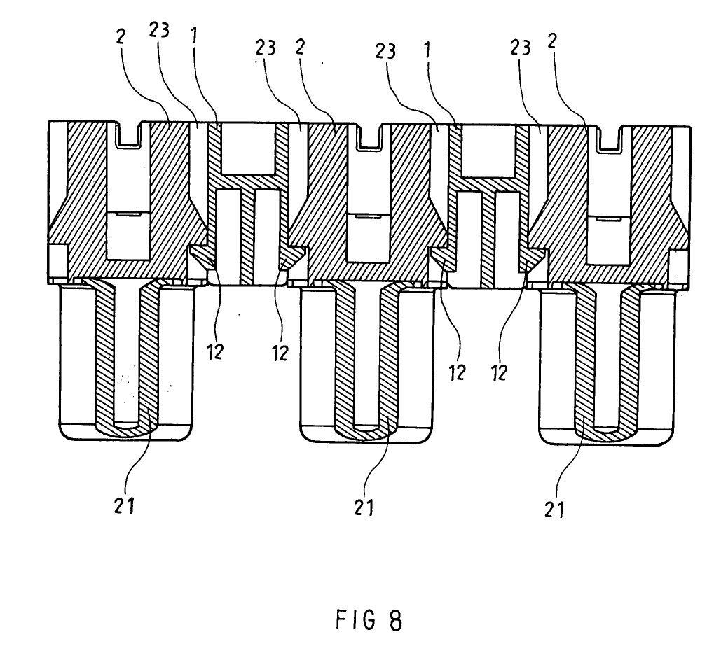

Referring to FIG. 7 and FIG. 8, after assembly, the male pedestals 1 and the female bases 2 are fixed by the protruding clip ribs 11 and the concave slots 22, the clip hooks 12 of the male pedestals 1 go over the clip slots 23 and hook on the front wall of the clip slots 23 to combine male pedestals 1 and the female bases 2 firmly together without loosing.

While a preferred embodiment of the invention has been shown and described in detail, it will be readily understood and appreciated that numerous omissions, changes and additions may be made without departing from the spirit and scope of the invention.

What is claimed is:

1. A combinational AV socket comprising:
a male pedestal with cross section in “I” shape, a pair of dovetail shape protruding clip ribs are on both center sides of said male pedestal, a pair of clip hooks with proper elasticity are on top and down of said protruding clip rib;
a female base with a pair of dovetail shape concave slots corresponding to said protruding clip ribs of said male pedestal on both center side, a pair of clip slots corresponding to said clip hooks are on top and down of said concave slot, said female bases with different colors combine with said male pedestals by said protruding clip ribs and said concave slots, said clip hooks of said male pedestals hook on the front wall of said clip slots for AV sockets with different colors.

2. The combinational AV socket recited in claim 1, wherein the front of the clip slot on both side of said female base has deeper depth than the rear to form a proper oblique slope for said clip hooks of said male pedestal to slide in.
